(19) United States
(12) Patent Application Publication
(10) Pub. No.: US 2007/0294373 A1
(43) Pub. Date: Dec. 20, 2007

(54) Management of Content Download

(76) Inventor: Simon HARRISON, Buckinghamshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/665,698

(22) PCT Filed: Oct. 24, 2005
(86) PCT No.: PCT/GB05/04086

§ 371 Date: Apr. 18, 2007

(30) Foreign Application Priority Data
Oct. 22, 2004 (EP) 04256514.3

(51) Int. Cl. G06F 15/16

(52) U.S. Cl. 709/219

(57) ABSTRACT

A proxy acting as a content gateway manages the download of content data from a server to a client PC. Rather than serving the content data directly to the client, the proxy intercepts the download and instead passes a download management entity (DME) to the client PC. A range of content management services can be applied to the downloaded content data (e.g. the data can be scanned for viruses). The DME, meanwhile, reflects the status of the download to the client PC: it may for example display the percentage downloaded or the fact that the downloaded data is being scanned for viruses. In one particular embodiment, having established that the downloaded data is clear of undesirable content (e.g. viruses, pornographic content etc.), the DME then streams the downloaded data to the client PC.

### FIELD OF THE INVENTION

The present invention relates to the management of content download between a server and a client, and in particular to a system in which content services are provided by a network-based device acting as a content security gateway (CSG).

### BACKGROUND TO THE INVENTION

Internet Service Provider (ISP)-sited download filters are becoming popular as a way of removing undesirable content before it arrives at a user's personal computer (PC). This content may contain viruses, be of inappropriate nature for the subscriber (e.g. adult material destined for a child's computer) or simply be unwanted by the subscriber (e.g. spam email). For the purposes of content download, such a filter appears in the middle of a client-server connection, and may be implemented as a standard proxy (where the client must be configured to send all its requests to the proxy) or as a transparent proxy (where the client is unaware of the filtering entity). Transparent proxies are convenient because they require no modification to the client (or server) and therefore such a proxy may be used even if the client does not support a standard proxy, or if the client is unwilling to configure a standard proxy.

Any filter device, such as an in-line virus scanner, sitting between a client and server interferes with the download process as perceived by the user. This interference manifests itself either as long delays proportional to the content length before a download commences, or in part of the infected content arriving at the subscriber's PC before the transfer is aborted. Additionally, any long delay might cause some client software to abort the download. The user receives no feedback for them to ascertain what is happening and how to proceed. The long delay could be a problem with the web server or normal filtering operation; the short file could be a broken download or an infected file.

### SUMMARY OF THE INVENTION

According to one aspect of the present invention, a network-based method for managing the download of content from a server to a client through a proxy residing within a communications network that acts as a content gateway, comprises the steps of:

receiving a request from a client for content download and passing this to a server;

receiving content from the server and processing the content within the content gateway according to a predetermined subscriber service to which the client has subscribed;

forwarding the content to the client; and,

providing the client with a download management entity (DME) which, subsequent to the request for content download from the client, receives feedback from the content gateway on the status of the download as it is processed by the content gateway,

wherein the content is streamed from the content gateway to a secure store on the client before content processing has been completed,

and wherein the content gateway sends a message to the DME when content processing has been completed, the DME thereafter deleting or releasing to a download area the downloaded content from the secure store depending on the nature of said message.

According to another aspect of the present invention, a network-based content gateway device for managing the download of content from a server to a client comprises:

means for receiving a request from a client for content download and for passing this to a server;

means for receiving content from the server and for processing the content within the content gateway according to a predetermined subscriber service to which the client has subscribed;

means for serving the client with a download management entity (DME) as a substitute for the requested content;

means for communicating with the DME to provide feedback from the content gateway device on the status of the content download as it is processed by the content gateway;

means for forwarding the content to a secure store on the client before content processing has been completed; and,

means for sending a message to the DME when content processing has been completed, the message indicating whether the DME should delete or release the downloaded content from the secure store.

According to a further aspect of the present invention, a computer program product for installation within a networked-based device comprises computer executable instructions for carrying out the steps of:

receiving a request from a client for content download and passing this to a server;

receiving content from the server and processing the content within the content gateway according to a predetermined subscriber service to which the client has subscribed;

serving the client with a download management entity (DME) subsequent to the request for content download from the client as a substitute for the requested content;

communicating with the DME to provide feedback from the content gateway device on the status of the download as it is processed by the content gateway;

forwarding the content to a secure store on the client before content processing has been completed; and,

means for sending a message to the DME when content processing has been completed, the message indicating whether the DME should delete or release the downloaded content from the secure store.

In the present invention, a network-based device provides a content download management service to subscribers when connecting to servers. The invention offers a download management entity (DME) at the subscriber-end that provides feedback on the download of content whilst the content is being processed by the device. Typical content processing includes virus scanning, web-access filtering, anti-spam filtering etc. The actual form of the content processing is not a feature of the present invention.

In the preferred implementation, the system is distributed as follows:

1) a client-side DME on the subscriber's PC (web page, web with JavaScript, web with ActiveX control, web page with Java etc) which provides user feedback during the file filtering and downloading process; and,

2) a delivery mechanism for the client-side DME residing within the networked-based device such that it arrives on the subscriber's PC and is executed.

The client-side DME may become resident on the subscriber's PC by one of three methods described below, although others are possible:

i. the client-side DME is served to the subscriber's PC each time content is downloaded by the subscriber;

ii. the client-side DME is initially served to the subscriber PC, which then stores this entity in its cache for future use. The client-side DME is not served again until it no longer exists in the subscriber's PC cache; or

iii. the client-side DME is permanently installed on the subscriber's PC. A DME installer served to the subscriber PC when content is first downloaded may install the DME in this case.

In one implementation of the present invention, the user clicks on a web page link to perform a file download and the subscriber's PC sends an HTTP GET request to the web server. The web server returns the file, which is deemed appropriate for processing by a content security gateway (CSG) acting as a proxy. Since the associated filtering operation implemented by the CSG may require visibility of the entire file before it can be passed as acceptable, the actual file is initially substituted by a DME and the user instead receives this. As part of the substitution process, the user's browser is then directed by the CSG to load and execute the DME. This may be achieved, for example, by changing the MIME Type from that of the original content to application/octet-stream, or by modifying the filename extension. Meanwhile the CSG continues to receive the original file from the web server.

The DME may be provided in one of the following forms (although this list is not exhaustive):

i. HTML page with automatic refresh/redirect;

ii. HTML page containing JavaScript; or

iii. executable content such as a browser plug-in or directly executable application.

Preferably, the download includes a unique identifier, allowing the DME to request information about the original file as it is being filtered. Preferably, this identifier is a cryptographically secure string to prevent unauthorised clients attempting to access 3^{rd} party files as they progress through the filter.

As the CSG filter works through the file, it makes available progress information relating to the filtering operation. The DME can request this information, referenced through the unique identifier, to provide the user with feedback that the filtering process is progressing.

In the preferred embodiment, the file is streamed down from the CSG to the client before the associated filter has determined whether the file is suitable for consumption. In this case, the DME handles the reception of the file and stores it securely, either in memory or in a temporary area on disk, until it has been fully downloaded and the CSG has sent a status update indicating that the file has passed successfully through the associated filter. At this point, the file is released to the user's requested download file area.

A further extension may be implemented when the CSG is linked to a cache. The present invention may be implemented with respect to the cache such that only content which has had security services applied is stored in the cache, and such that any content which is resident in the cache is served to the subscriber without the need to apply these content security services again each time this content is served from the cache. In such cases, it is also not necessary to serve the DME to the client before downloading the content from the cache. This ensures the user receives “clean” or processed content without any delay. To ensure that the cache is kept free of any “unclean” content (e.g. an as of yet unknown virus which may be temporarily deemed to be clean by the CSG), the CSG filter periodically operates on all content stored in the cache, and when necessary, purges all content from the cache (e.g. after a major malware outbreak).

### BRIEF DESCRIPTION OF THE DRAWINGS

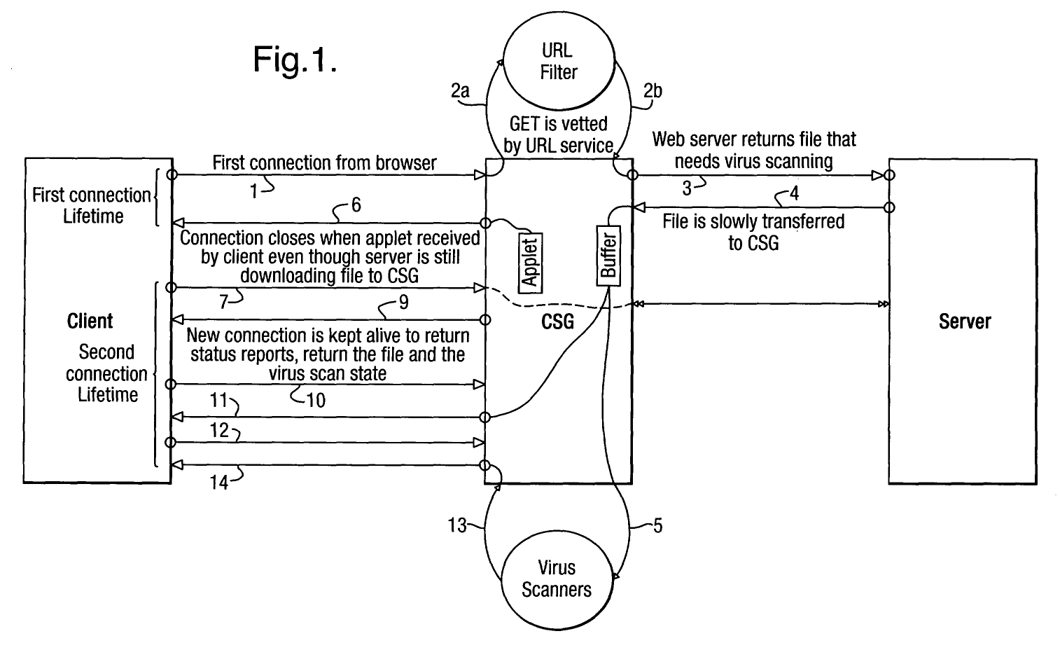

Examples of the present invention will now be described in detail with reference to the accompanying drawing, in which FIG. 1 shows an implementation of a Content Security Gateway in accordance with the invention that sits between a client (a subscriber's PC) and a web server.

### DETAILED DESCRIPTION

FIG. 1 shows a typical implementation of a transparent proxy Content Security Gateway (CSG) running both URL filtering and virus scanning services on web (HTTP) traffic. An example of a suitable CSG is described in more detail in our co-pending International patent application number PCT/GB2005/003577, filed on 15 Sep. 2005, entitled NETWORK-BASED SECURITY PLATFORM.

The CSG is a transparent filtering proxy device that sits between a subscriber (client PC) and a content server (e.g. internet web server). This CSG transparently proxies all web requests originated by the subscriber, both in the outgoing (server-bound) and incoming (client-bound) directions.

A typical content download process implemented in accordance with present invention will now be described in more detail. When the subscriber clicks on a file to download, his browser originates an HTTP GET request to the server address (step 1). This arrives at the CSG where it is vetted through an optional URL request filtering service (steps 2a/2b). Assuming this filter accepts the request, it passes unmodified to the server (step 3) and the server responds with the requested file (step 4).

The CSG identifies the returning file as one requiring filtering (in this case, virus scanning) and so substitutes the file for a download management entity (DME) which it sends to the subscriber's PC (step 6). It also directs the incoming server data to a storage buffer, as well as sending a copy to the virus scanner (step 5). If instead it is determined that no content-related services are to be provided by the CSG, the DME is not served to the subscriber's PC. If the CSG determines that the content-type is such that the content services can be applied with the CSG receiving only a fraction of the file such that no significant delay is incurred, the DME will not be served to the subscriber's PC since this is would introduce unnecessary latency. Furthermore, if the CSG determines that the provision of content services will not introduce any significant latency then the DME may not be served.

The CSG directs the subscriber's browser to execute the DME by supplying a modified MIME Type and filename extension with the DME. The DME then originates a GET status request (step 7) periodically to retrieve information about the downloading file. These connections are made to the server's address but are caught by the CSG where the cryptographically secure file ID is extracted and correlated against the progressing download (step 8). Then the status (e.g. % of file downloaded) is returned to the DME (step 9) where it is shown to the user.

Eventually, the file is fully downloaded and the virus scanner provides a pass/fail result. If the result is “pass” the last status request from the client (step 10) is used to return the file (step 11). Otherwise the result of the failed scan is returned (step 14).

In the preferred implementation, the file is streamed to the DME immediately (step 11) so that on providing the virus scan result (step 14) the DME on the subscriber's PC can decide whether to release the entire file to the user or to delete it.

The transparent filtering proxy at the CSG described above can be implemented in a dedicated hardware unit, or in software on a network-processing platform.

The system could readily be adapted for use in a non-transparent mode, offering the same advantages.

A further extension may be implemented when the CSG is linked to a cache. The present invention may be implemented with respect to the cache such that only content which has had security services applied is stored in the cache, and such that any content which is resident in the cache, is served to the subscriber without the need to apply these content security services again each time this content is served from the cache. In such cases, it is not necessary to serve the DME to the client before downloading the content from the cache. This ensures the subscriber receives “clean” or processed content without any delay. To ensure that the cache is kept free of any “unclean” content (e.g. an as of yet unknown virus which may be temporarily deemed to be clean by the CSG), the CSG filter periodically operates on all content stored in the cache using the latest processing rules, and when necessary, purges all content from the cache (e.g. after a major malware outbreak).

The content security gateway is not limited to offering just filtering operations. It could be used to give enhanced downloading experience such as a download-manager-like functionality based in the server.

The present invention is applicable to any content delivery system in which the primary downloaded content can be substituted for a DME that can then perform the actual download whilst providing progress information and protection from unscreened content. For example, the invention may be used in a WAP-based content delivery system for mobile content.

The present invention is also not limited to a filtering proxy implementation. It can be used in cases where the proxy performs download enhancement functions such as retrieving a file from multiple sources to give a higher aggregate download rate to the subscriber's PC.

The use of the DME can selectively be applied based on a number of criteria. The primary reasons for substituting a DME are to provide some user feedback during the download process, and to accelerate the process by streaming a potentially unsafe file to a secure area on the subscriber's PC before the scan has completed. Thus, for small files, it is not necessary to perform the substitution. A hold-off period of, for example, 10 seconds can be applied and if, at the end of this period, the file hasn't downloaded (or is not close to the end), then the substitution occurs and the DME is started. However if the file completes within this time then it is filtered and sent to the subscriber without any DME intervention. Other metrics can be used, such as file size, although the timed period is likely to give the best consistent user experience.

1. A network-based method for managing the download of content from a server to a client through a proxy residing within a communications network that acts as a content gateway, comprising the steps of:
receiving a request from a client for content download and passing the request to a server;
receiving content from the server and processing the content within the content gateway according to a predetermined subscriber service to which the client has subscribed; and,
providing the client with a download management entity (DME) which, subsequent to the request for content download from the client, receives feedback from the content gateway on the status of the download as it is processed by the content gateway,
wherein the content is streamed from the content gateway to a secure store on the client before content processing has been completed,
and wherein the content gateway sends a message to the DME when content processing has been completed, the DME thereafter deleting or releasing to a download area the downloaded content from the secure store depending on the nature of said message.

2. A method according to claim 1, in which the DME is presented as a web page.

3. A method according to claim 1, in which the DME is served to the client each time content is downloaded.

4. A method according to claim 1, in which the DME is initially served to the client where it is cached for future use.

5. A method according to claim 1, in which the DME is permanently installed at the client.

6. A method according to claim 5, wherein the DME is installed by an installer served to the client the first time content is downloaded.

7. A method according to claim 1, in which the DME is provided as an HTML page or executable content.

8. A method according to claim 1, in which the content download includes a unique identifier, wherein the content gateway receives requests from the DME, which include the unique identifier, about the status of the download as it is being processed by the content gateway.

9. A method according to claim 1, in which the content gateway makes available progress information relating to the content processing operation.

10. A method according to claim 1, in which the content gateway is linked to a cache, wherein only content which has been processed by the content gateway is stored in the cache, and such that any content which is resident in the cache, is served to the client without applying further content processing or executing a DME each time the same content is served from the cache.

11. A method according to claim 10, in which the content gateway periodically processes all content stored in the cache using updated processing rules.

12. A method according to claim 1, in which the content gateway is a transparent proxy.

13. A method according to claim 1, in which the content gateway is a non-transparent proxy.

14. A method according to claim 1, implemented over an Internet Protocol (IP) network.

15. A method according to claim 1, in which at least part of the communications network is a mobile network.

16. A method according to claim 1, in which the DME is not invoked when download time is below a predetermined threshold.

17. A method according to claim 1, in which the content processing includes filtering the content.

18. A method according to claim 1, in which communication between the client and the content gateway is cryptographically secure.

19. A network-based content gateway device for managing the download of content from a server to a client comprising:
means for receiving a request from a client for content download and for passing the request to a server;
means for receiving content from the server and for processing the content within the content gateway according to a predetermined subscriber service to which the client has subscribed;
means for serving the client with a download management entity (DME) as a substitute for the requested content;
means for communicating with the DME to provide feedback from the content gateway device on the status of the content download as it is processed by the content gateway;
means for forwarding the content to a secure store on the client before content processing has been completed; and,
means for sending a message to the DME when content processing has been completed, the message indicating whether the DME should delete or release the downloaded content from the secure store.

20. A computer program product for installation within a networked-based content gateway device comprising computer executable instructions for carrying out the steps of:
receiving a request from a client for content download and passing the request to a server;
receiving content from the server and processing the content within the content gateway device according to a predetermined subscriber service to which the client has subscribed;
serving the client with a download management entity (DME) subsequent to the request for content download from the client as a substitute for the requested content;
communicating with the DME to provide feedback from the content gateway device on the status of the download as it is processed by the content gateway device;
forwarding the content to a secure store on the client before content processing has been completed; and,
means for sending a message to the DME when content processing has been completed, the message indicating whether the DME should delete or release the downloaded content from the secure store.
